(19) United States
(12) Patent Application Publication
(10) Pub. No.: US 2019/0029466 A1
(43) Pub. Date: Jan. 31, 2019

(54) SPHERICAL GRILLING APPARATUS

(71) Applicant: SUZHOU TIETA MACHINERY MANUFACTURING CO., LTD., Suzhou (CN)

(72) Inventor: Jiawei ZHAO, Suzhou (CN)

(21) Appl. No.: 15/817,268

(22) Filed: Nov. 19, 2017

(30) Foreign Application Priority Data
Jul. 31, 2017 (CN) 201710640574.9

(51) Int. Cl. A47J 37/07

(52) U.S. Cl. CPC A47J 37/0763

(57) ABSTRACT

The present invention is directed to providing a spherical grilling apparatus. The spherical grilling apparatus comprises a spherical frame, which has a brazier inside and a supporting device outside; a half portion of the upper half of the spherical frame is a movable door, which can be rotated around the horizontal axis to such a position that this half portion substantially overlaps with the other half portion of the upper half of the spherical frame. The spherical frame provided outside the brazier can achieve the effect of isolation; the movable door of the spherical frame is easy to open, allowing easy addition of fuel to the brazier; the inner and outer diameters of the movable door are consistent with those of the frame body, so that the appearance of the apparatus is regular and beautiful.

### FIELD OF THE INVENTION

The present invention relates to the field of outdoor products, and in particular to a grilling apparatus.

### BACKGROUND OF THE INVENTION

An outdoor or field grilling apparatus has been widely used in the US market. It generally comprises a brazier and a holder, having a certain security risk due to the opening design for most of the braziers.

An improvement to this problem is to provide a closed frame at the upper portion of the brazier together with a horizontally slidable door. This structure is complex because the horizontally slidable door needs to be equipped with a sliding rail, and the opening to which the slidable door corresponds is so small that adding fuel is slow. Besides, the slidable door is generally slid on the outside of the frame and protrudes there, making the appearance not neat and beautiful.

### CONTENTS OF THE INVENTION

The technical problem to be solved by the present invention is to provide an outdoor grilling apparatus that is convenient for the addition of fuel and suitable for the isolation of flame.

In order to solve the above technical problem, the present invention adopts the following technical solution: A spherical grilling apparatus is provided, comprising a spherical frame having a brazier inside and a supporting device outside; a half portion of the upper half of the spherical frame is a movable door, which can be rotated around the horizontal axis to such a position that this half portion substantially overlaps with the other half portion of the upper half of the spherical frame.

Furthermore, the movable door, having the same diameter as that of the frame body, may be combined with the frame body into a complete sphere.

Furthermore, the rotation axis of the movable door is spaced from the axis at the opening of the movable door on the frame body.

Furthermore, the movable door is provided on both sides with a connection ear, which is provided with a guide groove; a guide post, slidably arranged in the guide groove, is provided on the outside of the opening of the frame body.

Furthermore, a hem is provided at the opening of the frame body and the outer edge of the movable door.

Furthermore, the brazier is also provided with a grilling net, which is connected with a traction device comprising a traction rope and a rotary handle, the traction rope being connected to the grilling net, the rotary handle being fixed at the outside of the frame body.

The present invention is advantageous in the following aspects: The spherical frame provided outside the brazier can achieve the effect of isolation; the movable door of the spherical frame is easy to open, allowing easy addition of fuel to the brazier; the inner and outer diameters of the movable door are consistent with those of the frame body, so that the appearance of the apparatus is regular and beautiful.

### BRIEF DESCRIPTION OF THE DRAWINGS

The present invention will be further described below with reference to drawings.

FIG. 1 is a schematic view of the structure of the present invention.

List of reference numbers: 1. A frame body; 2. a movable door; 3. a brazier; 4. a support leg; 5. a connection ear; 6. a grilling net; 7. a rotary handle; 8. a traction rope; and 9. a hem.

### DETAILED DESCRIPTION OF THE EMBODIMENTS

The present invention will be described below in detail with reference to drawings and embodiments.

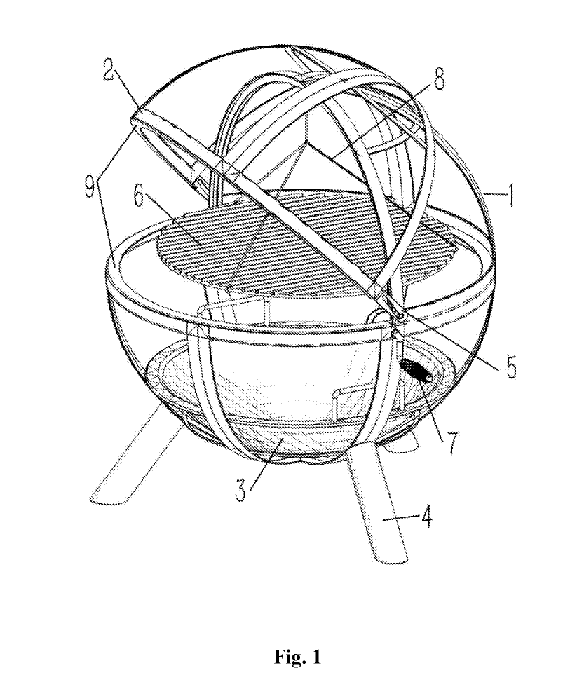

In a spherical grilling apparatus as shown in FIG. 1, the frame body 1 and the movable door 2, both having a metal frame structure, are combined together into a complete spherical frame, wherein the frame body 1 occupies three quarters of the sphere, the movable door 2 occupies a quarter of the sphere, and the opening of the frame body 1 and the outer frame of the movable door 2 are provided with a hem 9. The movable door 2 is provided on both sides with a connection ear 5, which is provided with a guide groove; the frame body 1 is provided with a guide post, which is slidably provided in the guide groove of the connection ear 5. When the spherical frame is in the closed state, the hem on the movable door 2 is in contact with that on the frame body 1, and the guide post on the frame body 1 is located at the end of the guide groove on the connection ear 5 near the movable door 2. The movable door 2 is pulled outward so that the guide post on the frame body 1 slides in the guide groove on the connection ear 5 to the end remote from the movable door 2, and then the movable door 2 is rotated upward to expose the notch on the frame body 1.

The frame body 1 is provided on the inner bottom with a brazier 3, and the fuel is added to the brazier 3 after the movable door 2 is opened. The brazier is also provided with a grilling net, which has a grid structure and can cover the brazier 3 to protect the user's safety. The grilling net 6 is connected with a traction rope 8, and a rotary handle 7 is fixed at the outside of the frame body 1, with the traction rope 8 attached to the frame body 1 and connected to the rotary handle 7, so that the grilling net 6 can be lifted with the rotary handle 7, which is convenient, fast and securer. Three support legs 4 act as the external support means for the frame body 1 for facilitating the fixing of this apparatus.

While in use, opening the movable door 2, lifting the grilling net 6 with the rotary handle 5, adding fuel to the brazier 3 and igniting it, lowering the grilling net 6 with the rotary handle 5, covering the brazier 5 with the grilling net 6, and then closing the movable door 2. The fuel burns through the grilling net, without spreading out of the spherical frame. The metal spherical frame not only facilitates distribution of the heat of the fire, but also blocks no light of the fire, so that the apparatus can achieve not only the warming effect but also the lighting effect.

It is necessary to emphasize that what is described above is only a preferred example of the present invention and is not intended to limit the present invention in any way. Any and all simple amendments, equivalents, and modifications of the foregoing example in accordance with the technical substance of the present invention are intended to be within the scope of the technical solution of the present invention.

1. A spherical grilling apparatus, comprising a spherical frame having a brazier inside and a supporting device outside, wherein a half portion of an upper half of the spherical frame is a movable door, which can be rotated around a horizontal axis to such a position that the half portion substantially overlaps with a second half portion of the upper half of the spherical frame.

2. The spherical grilling apparatus according to claim 1, wherein the movable door, having the same diameter as that of a frame body, is combined with the frame body into a complete sphere.

3. The spherical grilling apparatus according to claim 1, wherein a rotation axis of the movable door is spaced from the horizontal axis at the opening of the movable door on the frame body.

4. The spherical grilling apparatus according to claim 3, wherein the movable door is provided on both sides with a connection ear, which is provided with a guide groove; and a guide post, slidably arranged in the guide groove, is provided on the outside of the opening of the frame body.

5. The spherical grilling apparatus according to claim 1, wherein a hem is provided at the opening of the frame body and an outer edge of the movable door.

6. The spherical grilling apparatus according to claim 1, wherein the brazier is also provided with a grilling net, which is connected with a traction device comprising a traction rope and a rotary handle, the traction rope being connected to the grilling net, the rotary handle being fixed at the outside of the frame body.
